(19) United States
(12) Patent Application Publication
(10) Pub. No.: US 2020/0400617 A1
(43) Pub. Date: Dec. 24, 2020

(54) BOUNDARY LOADED ACOUSTIC TESTING SYSTEM AND METHOD

(71) Applicant: Meyer Sound Laboratories, Incorporated, Berkeley, CA (US)

(72) Inventor: Roger Schwenke, Alameda, CA (US)

(21) Appl. No.: 17/013,335

(22) Filed: Sep. 4, 2020

Related U.S. Application Data
(63) Continuation of application No. PCT/US2019/022143, filed on Mar. 13, 2019.
(60) Provisional application No. 62/643,109, filed on Mar. 14, 2018.

(51) Int. Cl. G01N 29/04; G01M 7/02; G01N 29/14; G01N 29/22

(52) U.S. Cl. CPC G01N 29/045; G01M 7/025; G01N 2291/2694; G01N 29/223; G01N 29/14

(57) ABSTRACT

A boundary loaded acoustic testing system and method produces elevated amounts of acoustic energy in a defined test zone that can be utilized to induce vibrations in test articles that can fit within the test zone. The testing system and method is particularly suited to testing spacecraft and satellite components, such as solar panels, structural panels and dishes, having narrow dimensions in one plane, and which experience extreme vibrations during launch. A rigid boundary wall (15) is introduced into a space (12) and loudspeakers (11) direct acoustic energy at a test article (13) positioned in the test zone, which is a boundary-adjacent test zone (17) created immediately in front of the boundary wall. Preferably, the boundary wall (15) is situated in a lateral free field space to achieve a relatively narrow auto-correlation of the sound pressure fields in the test zone.

### CROSS-REFERENCE TO RELATED APPLICATIONS

This application is a continuation of International (PCT) Application No. PCT/US2019/022143 filed Mar. 13, 2019, which claims the benefit of U.S. Provisional Patent Application No. 62/643,109 filed Mar. 14, 2018. The foregoing applications are incorporated herein by reference.

### BACKGROUND

The present invention relates to environmental testing of structures (sometimes referred to herein as “test articles”), and has particular applications in the testing of spacecraft and satellite components that experience extreme vibrations in their normal operating environments. The invention more particularly relates to the use of acoustic transducers (loudspeakers) capable of delivering large amounts of acoustic energy for such tests.

Satellite components need to be tested before they are assembled onto the satellite to ensure they will survive the vibration induced by the sound of a rocket launch. Most of the sound power experienced by a satellite during launch are at low frequencies, typically at wavelengths of around 2 to 12 feet. Many of the satellite components (such as solar panels, structural panels and dishes) that require testing are narrower than 2 feet, and often no more than 6 inches, in one direction that can be designated the z-direction, but are long in other directions, namely, in the x-y plane perpendicular to the z-direction. To effectively test components of these dimensions, acoustic energy must be uniformly delivered to the component under test over the entire extent of the component.

One known method of acoustic testing is the reverberant chamber method. Using this testing method, a test article is placed at a distance from the sound source in an environment which is as reverberant as possible. The acoustic energy in the reverberations is used to increase the sound level and spatial uniformity of the field. However, in order to achieve spatial uniformity, the test article must be sufficiently far from the sound source such that the reverberant contribution to the acoustic energy is larger than the acoustic energy in the direct sound. Also, for spatial uniformity, the chamber needs to be large (much larger than the test article), and thus conventional loudspeakers cannot be used.

Another downside to the reverberant chamber testing method is that the auto-correlation of the sound field is far wider than occurs during actual launch conditions. During an actual launch there are generally few surfaces near the satellite components of interest that reflect acoustic energy back onto the components. In other words, sound vibrations generated in the past contribute negligibly to the sound level at the present moment. To reproduce actual launch conditions, the auto-correlation of the sound field needs to be relatively narrow such that the only sound vibrations that effect the test article are direct, real time vibrations and not delayed vibrations.

Another conventional acoustic vibration testing method is direct field acoustic testing. Using this method, conventional loudspeakers are placed in a circle around the test article with the acoustic energy produced by the loudspeakers being directed at the test article from all sides. While direct field acoustic testing avoids the wide auto-correlation issues associated with reverberant chamber testing, achievable sound pressure levels in the volume of space where the test article is positioned are limited. Also, the sound pressure fields produced by this test configuration generally require microphone placements that surround the test article, and therefore the microphones must be moved in order to get the test article in and out of the test setup.

### SUMMARY OF THE INVENTION

The present invention is directed to a system and method for acoustic vibration testing of test articles such as satellite components that takes advantage of the narrow dimensions of the components of a satellite that most often require testing. The system and method of the invention allow sound pressure levels to be achieved within a usable volume of space for testing purposes that are substantially higher than can be achieved using conventional vibration test methodologies. The elevated sound pressure levels can be achieved without an overly wide auto-correlation of the sound field, that is, an auto-correlation that does not accurately represent actual exposure during use. The acoustic vibration testing system and method of the invention further allows for advantageous placements of the microphones needed to monitor the test conditions, simplifying test set-up and procedures.

The system and method of the invention is particularly adapted to vibration testing test articles having a maximum dimension in one direction. In accordance with the invention, a rigid boundary wall is provided that extends in an x-y plane. A test article is placed next to the rigid boundary wall such that it lies within a defined boundary-adjacent test zone that extends in an x-y plane in front of the boundary wall. The depth of the boundary-adjacent test zone will correlate to the shortest wavelength of the acoustic energy to which a test article is to be subjected. The shorter this wavelength is the narrower the boundary-adjacent test zone. Test articles are chosen having a maximum depth throughout the x-y plane that allows the test article to fit substantially entirely within the boundary adjacent test zone.

Acoustic energy is directed at the test article positioned in the boundary-adjacent test zone. This is done from a location in front of the boundary wall that is displaced from the test zone. The acoustic energy can be produced from one or multiple sources. The rigid boundary wall bounding the boundary-adjacent test zone causes an increase in the sound pressure levels within the boundary-adjacent test zone, thus amplifying the intensity of the vibrations to which the test article in the test zone is subjected. Using the system and method of the invention, sound pressure levels can be achieved within a narrow but useful boundary-adjacent test zone that greatly exceed the sound pressure levels achieved using conventional direct field testing methods.

To be effective, the rigid boundary wall should have a very low absorption factor, generally no greater than about 0.5 and preferably no greater than 0.2, and still more preferably no greater than 0.1. Except for the boundary wall, the testing is preferably conducted in a lateral free field test environment to achieve a relatively narrow auto-correlation of the sound pressure fields in the test zone. As used herein “lateral free field” or simply “free field” shall be understood to mean environmental conditions where reflections from wall surfaces (other than the boundary wall described herein) are negligible. It is permissible and even beneficial to have reflective floor surfaces and permissible but not always beneficial to have reflective ceiling surfaces. (Reflective ceiling surfaces would be beneficial if the stack of loudspeakers used in the test reached the ceiling.)

### BRIEF DESCRIPTION OF THE DRAWINGS

FIG. 1 is a diagrammatic representation of a test set up for a conventional direct field acoustic testing method.

FIG. 2 is a diagrammatic representation of a test set up for an acoustic testing method in accordance with the invention.

FIG. 3 is a sound field plot illustrating the drop in sound pressure with distance for sound generated by a single loudspeaker in free space with no boundary such as a boundary wall.

FIG. 4 is a sound field plot illustrating variations in sound pressure levels generated by a single loudspeaker in a space bounded by a boundary wall where the output from the loudspeaker is directed at the boundary wall.

FIG. 5 is a sound field plot illustrating variations in sound pressure levels generated by a single loudspeaker in a space bounded by a boundary wall where the output from the loudspeaker is directed at the boundary wall, and showing a test article positioned in a boundary-adjacent test zone where an increase in sound pressure level occurs.

FIG. 6 is a sound field plot illustrating variations in sound pressure levels generated by two loudspeakers arrayed in a space bounded by a boundary wall where the output from the loudspeakers is directed at the boundary wall, and showing a test article positioned in a longer boundary-adjacent test zone where an increase in sound pressure level occurs.

FIG. 7 is a sound field plot illustrating variations in sound pressure levels generated by three loudspeakers arrayed in a space bounded by a boundary wall where the output from the loudspeakers is directed at the boundary wall, and showing a test article positioned in a still longer boundary-adjacent test zone where an increase in sound pressure level occurs.

### DESCRIPTION OF THE ILLUSTRATED EMBODIMENT

Environmental testing is the controlled replication in laboratory environmental conditions (heat, humidity, electromagnetic emission, vibration, sound, etc.) that a test structure will experience in actual use to ensure that the test structure will perform correctly when used outside the lab. The device(s) which replicate the environmental conditions are referred to as the input transducers because they provide the inputs to the environmental system. Where the environmental conditions sought to be replicated are sound vibrations, the input transducers are transducers capable of generating acoustic energy, i.e., loudspeakers.

Replication in a laboratory environment of the extremely high levels of acoustic energy to which some test structures, such as spacecraft or satellites, may be subjected presents particular challenges. Typically, such tests involve the use of one or multiple loudspeakers arranged so that their acoustic outputs are directed at the target structure or test article, with the delivery of acoustic energy from the loudspeaker(s) to the target structure being controlled by either a SIMO or MIMO controller.

In referring to the accompanying drawings, it is noted that all figures are illustrative of structures and sound fields that are placed or occur in space defined by perpendicular x, y and z axes. Only the x and z axes are shown. The y axis, which together with the x axis defines the x-y plane described herein, is perpendicular to the drawing page.

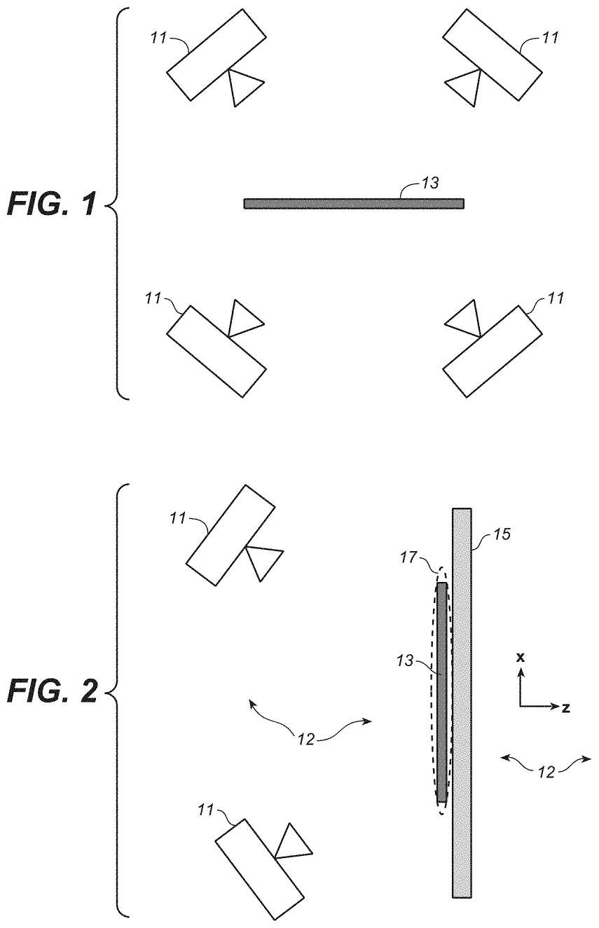

FIG. 1 illustrates a basic test set-up for direct field acoustic testing known in the prior art. Here it is seen that four loudspeakers 11 are arranged in a circle around a test article 13 such that their acoustic outputs are all directed at the test article, which is bombarded from all sides by the acoustic outputs of the four loudspeakers. Such tests are normally conducted in lateral free field conditions. The effectiveness of the tests will depend on the sound pressure levels and the uniformity of the sound pressure levels at the center of the loudspeaker array where the test article is located. For reasons described below, the sound pressure levels at the center of the loudspeaker array are greatly diminished as compared to the maximum SPL levels generated by the individual loudspeakers used in the test, resulting in a decrease in the efficacy of the test. To sonic extent this decrease in efficacy can be compensated for by adding loudspeakers to the test set-up, but this increases the complexity of the test set-up and environmental conditions under which the tests are conducted, and will not overcome difficulties in achieving uniformity of sound pressure levels within the test space.

FIG. 2 illustrates a test set-up for conducting tests in accordance with the method of the invention, wherein a boundary is introduced into the test space denoted in FIG. 2 by the numeral 12. As shown in FIG. 2, the boundary is in the form of a rigid boundary wall 15. This boundary wall will suitably have a low absorption factor, suitably no greater than about 0.5 and more suitably no greater than about 0.2, and preferably no more than 0.1. A relatively low absorption factor is necessary to maximize the amount of acoustic energy available for the vibration testing of the test article 13, which is seen to be positioned immediately in front of the boundary wall within a boundary-adjacent test zone. In FIG. 2, the boundary-adjacent test zone is denoted by the elongated dashed line oval 17.

In the set-up shown in FIG. 2, the acoustic outputs of loudspeakers 11, which are arrayed in front of the boundary wall 15, are directed toward the boundary wall at a suitable angle to provide coverage within the desired space in front of the boundary wall. As described in greater detail below, the boundary wall will cause a narrow zone of increased sound pressure to be created immediately in front of the boundary wall. This narrow zone of increased SPL provides the test zone 17 for the test article 13.

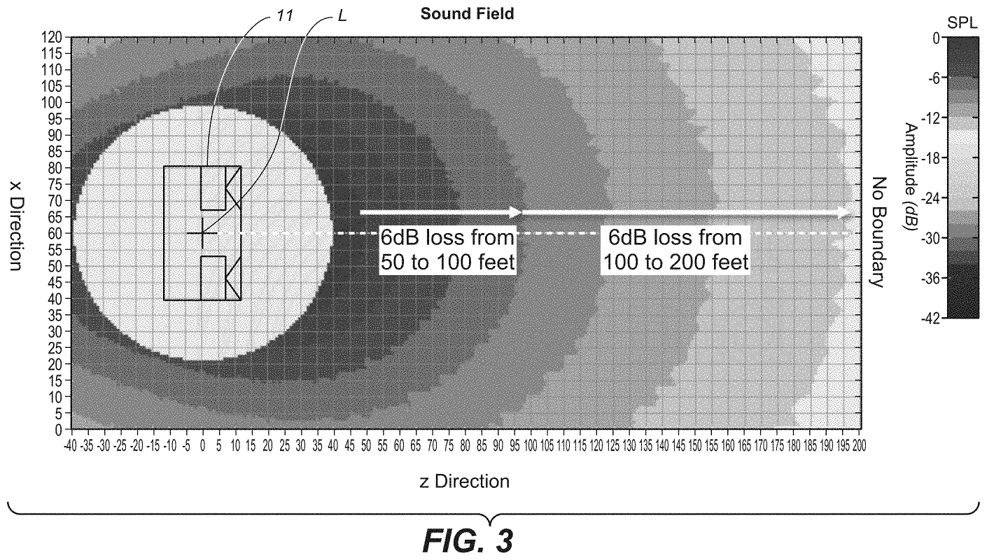

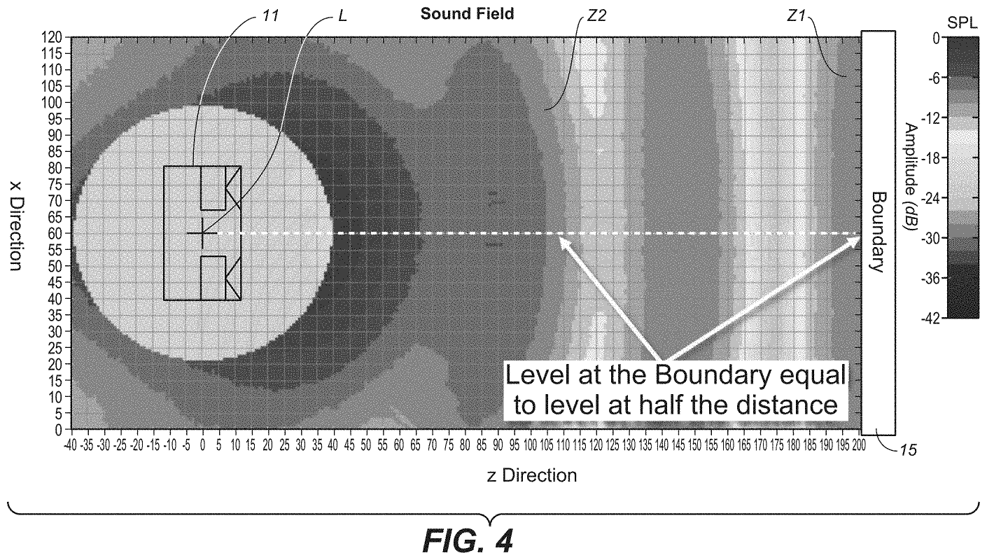

The effect of the boundary wall 15 shown in FIG. 2 on the sound field is illustrated by comparing the sound field plots in FIGS. 3 and 4, where different shades of grey represent different sound pressure levels ranging from the highest SPL (the darkest grey) to the lowest SPL (lightest grey). FIG. 3 is a sound field plot for the acoustic output of a single loudspeaker at a position L in free space, showing how the sound pressure decreases with distance from the loudspeaker. The sound pressure level decreases by 6 db for each doubling of distance from the loudspeaker in the space. FIG. 4 shows the sound field produced by the same loudspeaker after a rigid boundary in the form of illustrated boundary wall 15 is introduced into the sound field. By introducing this rigid boundary into the sound field, the sound pressure is doubled at locations that are less than one quarter wavelength from the boundary. This elevated SPL zone near the boundary is denoted Z1 in FIG. 4 (and as test zone 17 in FIG. 2) and can be advantageously used to perform tests on test articles of a size and shape that can fit within this zone.

Also, it is seen from the plot in FIG. 4 that the addition of the boundary creates a secondary zone Z2 removed from the boundary adjacent test zone Z1, which has an SPL level that matches the SPL level produced in the test zone. In one aspect of the method of the invention, this secondary zone Z2 is advantageously used for monitoring the SPL level in the test zone. By placing a microphone (not shown) in this secondary zone, the SPL level within the test zone can be monitored from a position outside of the boundary adjacent test zone Z1. This will allow test articles to be moved in and out of the test zone without having to move the microphones.

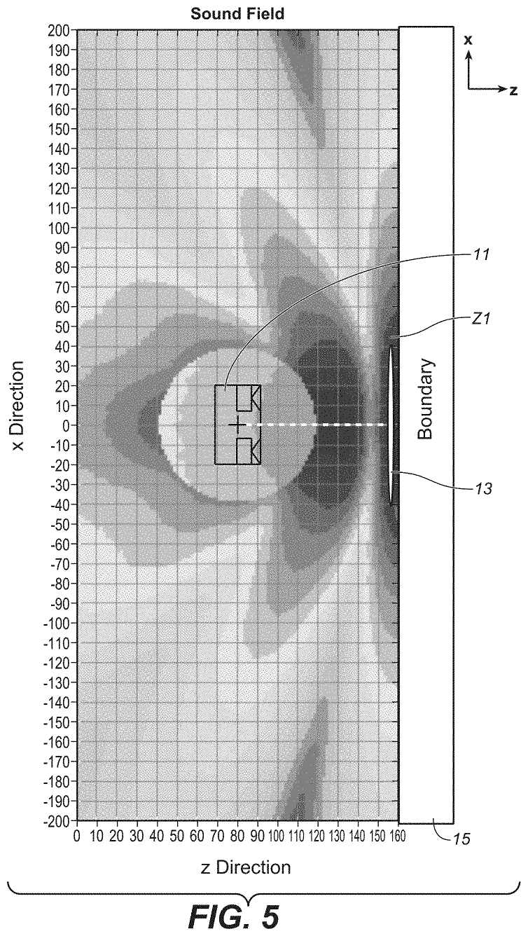

FIG. 5, like FIG. 4, shows the sound field produced by the same loudspeaker after a rigid boundary wall 15 is introduced into the sound field. The extent of the boundary-adjacent test zone Z1 in the x-direction of the x-y plane is shown in this figure along with a test article of suitable dimensions positioned in the test zone. (The extent of the boundary-adjacent test zone in the y-direction would normally be determined by the coverage of the loudspeaker system used for the test.) In FIG. 5, it is seen that the length of the test article 13 is such that it does not extend beyond the length of the test zone in the x-direction. Similarly, the depth of the test article does not exceed the depth of the test zone in the z-direction.

In regards to the placement of the one or more loudspeakers in front of the boundary wall, it is observed that loudspeakers have a maximum SPL that they can produce at a given distance. They also have a characteristic coverage angle outside of which the sound level drops off. In practicing the method of the invention, the loudspeaker should be close enough to the boundary 15 to produce the necessary SPL, but not so close that the edges of the test article end up outside of the loudspeaker coverage pattern. Preferably the loudspeakers will be at a distance from the boundary wall that is least wavelength at the shortest wavelength of interest, and no more than one wavelength at the longest wavelength of interest.

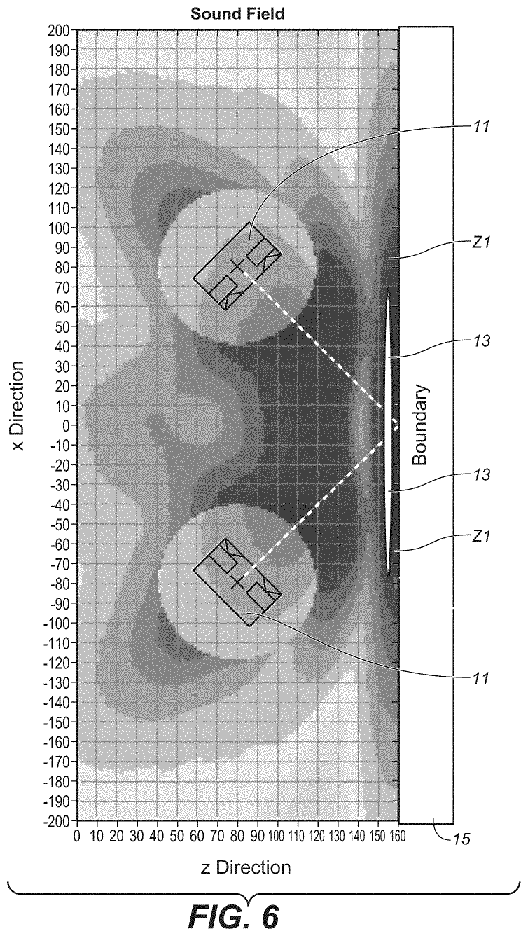

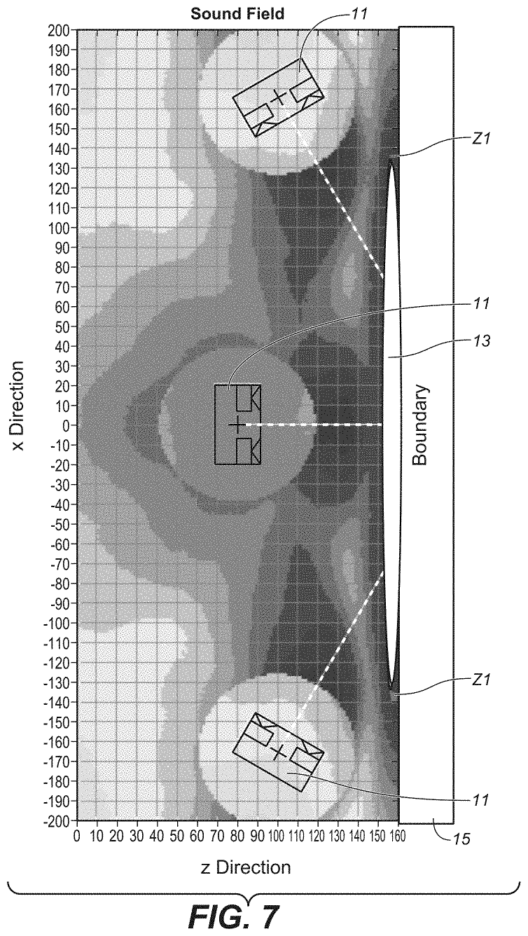

FIGS. 6 and 7 show how multiple loudspeakers can be used to increase both the size of the test zone Z1 as well as SPL levels within the test zone. In FIG. 6, two spaced apart loudspeakers 11 are arrayed in front of the boundary wall with each loudspeaker angled inwardly at about 45 degrees for directing their acoustic outputs at a target space in front of the boundary wall between the two loudspeakers. The boundary-adjacent test zone Z1 produced by this configuration is seen to be elongated as compared to the test zone Z1 in FIG. 5, which is produced by a single loudspeaker. FIG. 7 shows how test zone Z1 can be further enlarged for accommodating still larger test articles 13 by adding a third loudspeaker to the array. In this loudspeaker array, the inwardly angled loudspeakers are spread apart and a middle loudspeaker added for fill between the two end loudspeakers.

It will be appreciated that yet additional loudspeakers could be added to the loudspeaker arrangements described above for further enlarging the coverage area of the test zone and/or increasing SPL levels within the test zone. The number and orientation of the loudspeakers can be chosen to achieve a test zone of a desired size and one that has a substantially uniform SPL level throughout the zone.

In setting up a test in accordance with the invention, a test space must first be selected. Again, this will preferably be a space that provides a lateral free field test environment, as such a test environment will allow for a relatively narrow auto-correlation of the sound pressure fields in the test zone for the test article. This test space must either have a pre-existing rigid wall that can act as a boundary wall within the space, or such a wall will need to be introduced into the space.

The size of the boundary wall, that is, the degree to which it extends in the x-y plane, will suitably be chosen based on the long dimensions of the largest test articles to be tested. The boundary wall is ideally flat without any significant perturbations on the wall that would produce undesirable disruption of the sound field produced by the loudspeakers. (Small perturbations which do not exceed the wavelength of the smallest wavelength of the acoustic energy to which a test article is to be subjected will have no significant effect on the sound field in front of the wall.) However, it is not intended that the invention be limited to a perfectly flat wall. Rather, while not ideal, some degree of curvature or other irregularity in its reflective surface could be allowed, so long as SPL levels can be kept reasonably uniform throughout most of the test zone. Such surfaces, which can be described as generally extending an x-y plane, are considered to be within the scope of the invention.

A further aspect of setting up a test in accordance with the invention involves selecting one or more loudspeakers for the test space. As above-described, the number of loudspeakers chosen will depend on the size of articles to be tested, for example, the longest dimension of the solar panels of a satellite. The loudspeakers are positioned in front of the boundary wall, preferably at a distance that is least ½ wavelength at the shortest wavelength of interest and no more than one wavelength at the longest wavelength of interest. For satellite component testing, suitable loudspeakers would suitably deliver most all of their acoustic energy within a frequency range of about 30 Hz to about 500 Hz, and the distance between the loudspeaker and the boundary wall being no less than 1⅛ feet (0.34 meters) and no more than 37 feet (11.4 meters). In this application, equalization can be used to create an acoustic energy profile for the loudspeaker's output that can be matched to published frequency vibration profiles for the vibrations normally experienced by the satellite components in live conditions, typically in ⅓ octaves over the applicable frequency range.

In still a further aspect of the test set-up, microphones are deployed outside the boundary adjacent test zone for the test article to monitor SPL levels within the boundary adjacent test zone as the tests are conducted. The remote positioning of the monitoring microphone or microphones is possible because of the above-described characteristics of the sound field produced by the loudspeaker or loudspeakers in front of the barrier wall, namely, the existence of a secondary zone within the sound field removed from the wall that exhibits the same SPL levels as the boundary adjacent test region where the test article is to be tested. The monitoring microphone(s) are placed in this remote secondary zone, which can be located by taking SPL measurements within the sound field when the positioned loudspeakers are turned on. It is noted that the remote secondary test zone in which the monitoring microphone is placed need not exhibit the same SPL levels as the boundary-adjacent test zone so long as there is a correlation between the SPL levels in the two zones of the sound field that is understood and can be used to determine SPL levels in the test zone.

The present invention is an improvement over both the reverberant test method and direct field test methods earlier described. Advantages over the reverberant test method are several and include: i) the test article can be closer to the sound source, ii) the test chamber can be significantly smaller, iii) the auto-correlation of the sound field will be more realistic, iv) the acoustic environment of the test article is more like boundary loading experienced during the actual conditions being simulated such as a satellite launch, and v) conventional loudspeakers can be used for the test. Advantages over the other direct field test methods include that loudspeakers on one side of the test article can be eliminated, displaced microphone locations that experience the same sound pressure levels as the test article are available, and the acoustic environment of the test article is more like boundary loading experienced during the actual conditions being simulated, e.g., during a launch.

While the present invention has been described in considerable detail in the foregoing specification and accompanying drawings, it is not intended that the invention be limited to such detail, except as may be necessitated by the following claims.

I claim:

1. A method of acoustic vibration testing of a test article comprising:
selecting a test article having a maximum dimension perpendicular to an x-y plane correlated to the shortest wavelength of the acoustic energy to which a test article is to be subjected,
placing a test article next to a rigid boundary wall that generally extends in an x-y plane, wherein the test article lies substantially entirely within a boundary-adjacent test zone in front of the boundary wall, the depth of such boundary-adjacent test zone being correlated to the shortest wavelength of the acoustic energy to which a test article is to be subjected, and
from a position in front of the boundary wall and displaced from the boundary-adjacent test zone, directing acoustic energy at the test article located in the boundary-adjacent test zone, wherein the acoustic energy at any point in space is characterized by a sound pressure level, and such that the sound pressure level within the boundary-adjacent test zone in front of the boundary wall is increased due to the presence of the rigid boundary wall bounding the boundary-adjacent test zone.

2. The method of claim I wherein acoustic energy is directed at the test article from a single source of acoustic energy positioned in front of the rigid boundary wall.

3. The method of claim I wherein acoustic energy is directed at the test article from two sources of acoustic energy arrayed in front of the rigid boundary wall.

4. The method of claim 1 wherein acoustic energy is directed at the test article from multiple sources of acoustic energy arrayed in front of the rigid boundary wall.

5. The method of claim 1 wherein the boundary wall has an absorption coefficient no greater than about 0.5.

6. The method of claim 1 wherein the boundary wall has an absorption coefficient no greater than about 0.2.

7. The method of claim 1 wherein the boundary wall has an absorption coefficient no greater than about 0.1.

8. The method of claim 1 wherein acoustic energy directed toward a test article in the boundary-adjacent test zone is directed from at least one source of acoustic energy, and wherein the source of acoustic energy is positioned in front of the boundary wall at a distance of at least about one-half wavelength of the shortest wavelength of the acoustic energy to which a test article is to be subjected.

9. The method of claim 1 wherein acoustic energy directed toward a test article in the boundary-adjacent test zone is directed from at least one source of acoustic energy, and wherein the source of acoustic energy is positioned in front of the boundary wall at a distance of no more than about one wavelength of the longest wavelength of the acoustic energy to which a test article is to be subjected.

10. The method of claim 1 wherein acoustic energy directed at the boundary wall produces a secondary zone of acoustic energy in front of the boundary wall outside of the boundary-adjacent test zone having sound pressure levels substantially matching sound pressure levels in the boundary-adjacent test zone, and wherein the method further comprises placing a microphone in such secondary zone for measuring the sound pressure levels to which the test articles within the boundary-adjacent test zone are subjected.

11. The method of claim 1 wherein, except for the boundary wall, the testing is conducted in a lateral free field test environment.

12. A method of acoustic vibration testing of a test article comprising:
selecting a test article having a maximum dimension perpendicular to an x-y plane correlated to the shortest wavelength of the acoustic energy to which a test article is to be subjected,
placing a test article next to a rigid boundary wall lying in an x-y plane and having an absorption factor no greater than about 0.5, herein the test article lies substantially entirely within a boundary-adjacent test zone in front of the boundary wall, the depth of such boundary-adjacent test zone being correlated to the shortest wavelength of the acoustic energy to which a test article is to be subjected, said boundary wall being situated in a lateral free field test environment, and
from a position in front of the boundary wall and displaced from the boundary-adjacent test zone, directing acoustic energy at the test article located in the boundary-adjacent test zone, wherein the acoustic energy at any point in space is characterized by a sound pressure level, and wherein the sound pressure level within the boundary-adjacent test zone in front of the boundary wall is increased due to the presence of the rigid boundary wall bounding the boundary-adjacent test zone.

13. The method of claim 12 wherein the boundary wall has an absorption coefficient no greater than about 0.2.

14. The method of claim 12 wherein the boundary wall has an absorption coefficient no greater than about 0.1.

15. The method of claim 12 wherein acoustic energy is directed at the test article from at least two sources of acoustic energy arrayed in front of the rigid boundary wall.

16. The method of claim 12 wherein acoustic energy directed toward a test article in the boundary-adjacent test zone is directed from at least one source of acoustic energy, and wherein the source of acoustic energy is positioned in front of the boundary wall at a distance of at least about one-half wavelength of the shortest wavelength of the acoustic energy to which a test article is to be subjected.

17. The method of claim 16 wherein acoustic energy directed toward a test article in the boundary-adjacent test zone is directed from at least one source of acoustic energy, and wherein the source of acoustic energy is positioned in front of the boundary wall at a distance of no more than about one-half wavelength of the longest wavelength of the acoustic energy to which a test article is to be subjected.

18. A test system for acoustic vibration testing of a test article comprising:
a rigid boundary wall generally extending in an x-y plane and positioned in a laterally free field test environment, and
at least one loudspeaker positioned in front of the boundary wall, said loudspeaker having an acoustic output and the acoustic output of said loudspeaker being directed at said boundary wall, wherein a boundary-adjacent test zone is created in an x-y plane in front of the boundary wall which exhibits an elevated high sound pressure level.

19. The test system of claim 18 wherein the boundary wall has an absorption coefficient no greater than about 0.5.

20. The test system of claim 18 wherein the boundary wall has an absorption coefficient no greater than about 0.2.

21. The test system of claim 18 wherein the boundary wall has an absorption coefficient no greater than about 0.1.

22. The system of claim 18 wherein the at least one loudspeaker is positioned in front of the boundary wall at a distance of at least about one-half wavelength of the shortest wavelength of the acoustic energy to which a test article is to be subjected.

23. The system of claim 18 wherein the at least one loudspeaker is positioned in front of the boundary wall at a distance of no more than about one wavelength of the longest wavelength of the acoustic energy to which a test article is to be subjected.

24. The system of claim 18 wherein the acoustic output of the loudspeaker that is directed at the boundary wall produces a secondary zone of acoustic energy in front of the boundary wall outside of the boundary-adjacent test zone which has sound pressure levels substantially matching sound pressure levels in the boundary-adjacent test zone, and wherein the test system further comprises at least one microphone in such secondary zone for measuring the sound pressure levels to which the test article positioned within the boundary-adjacent test zone is subjected.

25. A test system for acoustic vibration testing of a test article comprising:
a rigid boundary wall lying in an x-y plane and positioned in a lateral free field test environment and having an absorption coefficient no greater than about 0.5,
at least one loudspeaker positioned in front of the boundary wall at a distance of at least about one-half wavelength of the shortest wavelength of the acoustic energy to which a test article is to be subjected and no more than about one wavelength of the longest wavelength of the acoustic energy to which a test article is to be subjected,
said loudspeaker capable of producing an acoustic output directed at said boundary wall such that a sound field is produced in front of the boundary wall which includes a boundary-adjacent zone extending in an x-y plane immediately in front of the boundary wall which exhibits elevated sound pressure levels, wherein a test article of suitable dimensions can be placed in the boundary-adjacent test zone for acoustic vibration testing, and
at least one microphone placed in a remote secondary zone in front of the boundary wall for monitoring the sound pressure levels to which the test article positioned within the boundary-adjacent test zone is subjected, wherein the sound pressure levels in such secondary zone correlate to the elevated sound pressure levels in the boundary-adjacent test zone produced by the acoustic output of said loudspeaker.

26. The test system of claim 25 wherein two or more loudspeakers are positioned in front of the boundary wall, each of said loudspeakers being positioned at a distance in front of the boundary wall of at least about one-half wavelength of the shortest wavelength of the acoustic energy to which a test article is to be subjected and no more than about one wavelength of the longest wavelength of the acoustic energy to which a test article is to be subjected, and each of the loudspeakers having an acoustic output and the acoustic output of each loudspeaker being directed at said boundary wall such that a boundary-adjacent test zone is produced in an x-y plane in front of the boundary wall which exhibits elevated high sound pressure levels.

27. The test system of claim 25 wherein the boundary wall is flat without any curvature or perturbations large enough to have a significant effect on the sound field in front of the wall which is produced by the loudspeakers.

28. The test system of claim 27 wherein the boundary wall has an absorption coefficient no greater than about 0.1.
